(19) United States
(12) Patent Application Publication
(10) Pub. No.: US 2010/0026733 A1
(43) Pub. Date: Feb. 4, 2010

(54) PLASMA DISPLAY DEVICE

(75) Inventor: Kazuhiro Yamada, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/515,627

(22) PCT Filed: Oct. 29, 2008
(86) PCT No.: PCT/JP2008/003090

§ 371 Date: May 20, 2009

(30) Foreign Application Priority Data
Nov. 5, 2007 (JP) 2007-286983

(51) Int. Cl. G09G 5/10

(52) U.S. Cl. 345/690; 345/60

(57) ABSTRACT

A plasma display device includes a plasma display panel having a plurality of discharge cells each having a data electrode, a data electrode driving circuit for driving the data electrodes, and an image signal processing circuit for performing a signal processing on an image signal and supplying the processed image signal to the data electrode driving circuit. The image signal processing circuit performs a first signal processing on an image signal to be displayed in a central region of an image region of the plasma display panel, and performs a second signal processing on an image signal to be displayed in a peripheral region of the image region. The second signal processing outputs the image signal which needs less power consumption of the data electrode driving circuit than the first signal processing.

### TECHNICAL FIELD

The present invention relates to a plasma display device which is an image display device using a plasma display panel.

### BACKGROUND ART

In an image display device that performs display of gradation using subfields, such as a plasma display device using a plasma display panel (hereinafter, simply referred to as “panel”), quality deterioration of noisy image, called a dynamic false contour, may be observed in a motion image region. The dynamic false contour is a phenomenon that occurs when the pattern of subfields for causing discharge cells to emit light discontinuously changes with respect to a continuous change of gradation values. As well known in the art, if the number of subfields increases, the dynamic false contour is improved. However, if the number of subfields increases, a time which can be used for light emission is shortened, and necessary luminance is not obtained.

For this reason, there is an attempt to suppress the dynamic false contour by limiting a combination of subfields in a region where there is a movement, without increasing the number of subfields too much. This attempt is disclosed in, for example, Patent Document 1. Such an image display device limits gradations to be used for display so as to display an image by a combination of gradations, at which a dynamic false contour is difficult to occur, and adds pseudo gradations using dithering, thereby compensating image quality deterioration due to a decrease in the number of gradations.

However, if the gradations are further limited in order to increase a dynamic false contour suppression effect, a pattern for dithering is easily noticeable, and the number of gradations to be actually expressed decreases.

In order to solve this problem, for example, the following method is disclosed. In this method, a region where the gradations have a gradient and there is a movement is detected from image signals. Then, one of a plurality of corrected gradations set for the gradations of the image signals is selected in accordance with the magnitude or direction of the movement of the region and the magnitude or direction of the gradient of the gradations and substituted for original gradation. In this way, an intermediate non-lighting subfield (a non-lighting subfield having a luminance weight smaller than a lighting subfield having a maximum luminance weight), which causes a dynamic false contour, is dispersed, thereby suppressing the dynamic false contour. Such a method is disclosed in, for example, Patent Document 2.

Meanwhile, in order to display an image using the panel, a plurality of data electrodes need to be independently driven on the basis of image signals. Then, in order to drive the data electrodes, stray capacitance between a data electrode and a scan electrode, between a data electrode and a sustain electrode, or between adjacent data electrodes needs to be charged and discharged which consumes power.

If the image processing described in Patent Document 2 is performed, the dynamic false contour can be suppressed to the extent that it is almost unrecognizable, but the number of subfields in which a light-emitting pixel and a non-light-emitting pixel are likely to be close to each other increases. For this reason, power required for driving the data electrodes increases. In recent years, with advancement of high definition and large screen of the panel, inter-electrode stray capacitance increases. As a result, there is an urgent need to suppress power required for driving the data electrodes.

[Patent Document 1] Japanese Patent Unexamined Publication No. 2000-276100

[Patent Document 2] Japanese Patent Unexamined Publication No. 2004-4782

### DISCLOSURE OF THE INVENTION

The invention has been made in consideration of the above-described problems, and it is an object of the invention to provide a plasma display device that can suppress an increase in power consumption and can effectively suppress a dynamic false contour.

A plasma display device includes a plasma display panel having a plurality of discharge cells each having a data electrode, a data electrode driving circuit for driving the data electrodes, and an image signal processing circuit for performing a signal processing on an image signal and supplying the processed image signal to the data electrode driving circuit. The image signal processing circuit performs a first signal processing on an image signal to be displayed in a central region of an image region of the plasma display panel, and performs a second signal processing on an image signal to be displayed in a peripheral region of the image region. The second signal processing outputs the image signal which needs lower power consumption of the data electrode driving circuit than the image signal output by the first signal processing.

### BRIEF DESCRIPTION OF THE DRAWINGS

FIG. 1 is an exploded perspective view showing the structure of a panel which is used in an embodiment of the invention.

FIG. 2 is a diagram showing the electrode arrangement of a panel which is used in the embodiment of the invention.

FIG. 3 is a diagram schematically showing inter-electrode capacitance of the panel which is used in the embodiment of the invention.

FIG. 4 is a diagram showing driving voltage waveforms to be applied to respective electrodes of a panel of a plasma display device according to the embodiment of the invention.

FIG. 5A is a diagram showing coding of a plasma display device according to the embodiment of the invention.

FIG. 5B is a diagram showing coding of a plasma display device according to the embodiment of the invention.

FIG. 6 is a circuit block diagram of a plasma display device according to the embodiment of the invention.

FIG. 7 is a circuit block diagram showing the details of an image signal processing circuit in a plasma display device according to the embodiment of the invention.

FIG. 8 is a diagram illustrating the operation of an image region signal generation section in a plasma display device according to the embodiment of the invention.

FIG. 9 is a schematic view illustrating the operation of an image signal selection circuit in a plasma display device according to the embodiment of the invention.

FIG. 10 is a circuit block diagram showing a first false contour suppression circuit in a plasma display device according to the embodiment of the invention.

FIG. 11A is a diagram illustrating why a dynamic false contour occurs in a gradient gradation region where there is a movement.

FIG. 11B is a diagram illustrating why a dynamic false contour occurs in a gradient gradation region where there is a movement.

FIG. 12 is a diagram showing a correction pattern of a first false contour suppression circuit in a plasma display device according to the embodiment of the invention.

FIG. 13A is a diagram showing a pattern having a gradation “164” and a gradation “172” arranged checkerwise.

FIG. 13B is a diagram showing a pattern having a gradation “164” and a gradation “172” arranged checkerwise.

FIG. 13C is a diagram showing a pattern having a gradation “164” and a gradation “172” arranged checkerwise.

FIG. 14 is a diagram for estimation of power consumption of a data electrode driving circuit when a checked pattern is displayed.

### DESCRIPTION OF REFERENCE NUMERALS AND SIGNS

10: panel
22: scan electrode
23: sustain electrode
24: display electrode pair
32: data electrode
41: image signal processing circuit
42: data electrode driving circuit
43: scan electrode driving circuit
44: sustain electrode driving circuit
45: timing generation circuit
51: first false contour suppression circuit
52: second false contour suppression circuit
55: selection signal generation circuit
56: image signal selection circuit
58: image data conversion circuit
61: image region signal generation section
63: random number generation section
64: binarization section
65: binarization selection section
72: correction value generation section
73: correction value switching section
74: addition section
75: subtraction section
76: delay section
77: addition section
100: plasma display device

### PREFERRED EMBODIMENTS FOR CARRYING OUT THE INVENTION

Hereinafter, an embodiment of the invention will be described with reference to the drawings.

### Embodiment

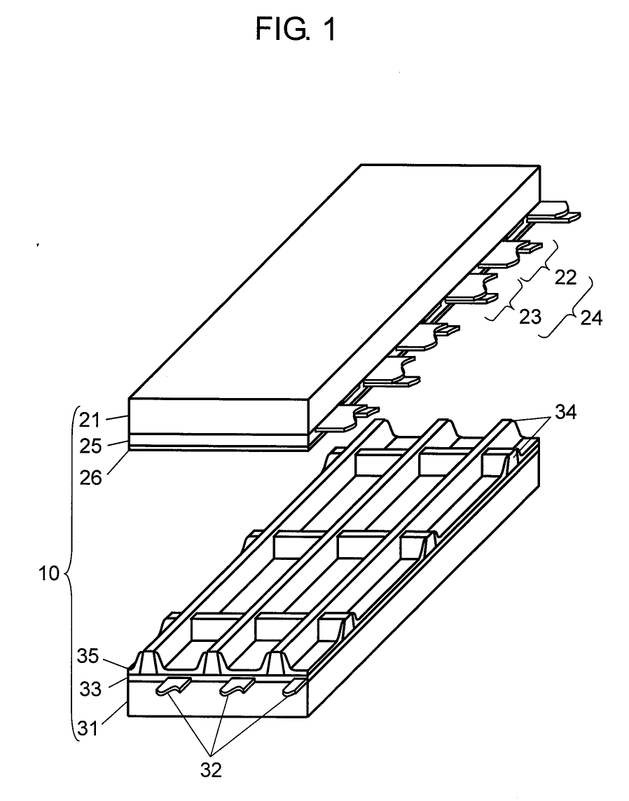

FIG. 1 is an exploded perspective view showing the structure of panel 10 which is used in an embodiment of the invention. A plurality of display electrode pairs 24 each having scan electrode 22 and sustain electrode 23 are formed on front substrate 21 made of glass. Dielectric layer 25 is formed so as to cover scan electrode 22 and sustain electrode 23, and protective layer 26 is formed on dielectric layer 25. A plurality of data electrodes 32 are formed on rear substrate 31. Dielectric layer 33 is formed so as to cover data electrodes 32, and curb-shaped barrier rib 34 is formed on dielectric layer 33. Fluorescent layer 35 is provided on the side surfaces of barrier rib 34 and on dielectric layer 33 to emit light of respective colors of red, green, and blue.

Front substrate 21 and rear substrate 31 are arranged to be opposite each other with a minute discharge space such that display electrode pairs 24 and data electrodes 32 intersect each other. Front substrate 21 and rear substrate 31 are bonded to each other at the outer circumferences thereof by a sealing material, such as glass frit or the like. The discharge space is filled with, for example, mixed gas of neon and xenon as discharge gas. The discharge space is divided into a plurality of sections by barrier rib 34, and discharge cells are formed at the intersections of display electrode pairs 24 and data electrodes 32. The discharge cells are discharged and emit light, thereby displaying an image.

The structure of panel 10 is not limited to the above structure, and it may have a stripe-shaped barrier rib, for example.

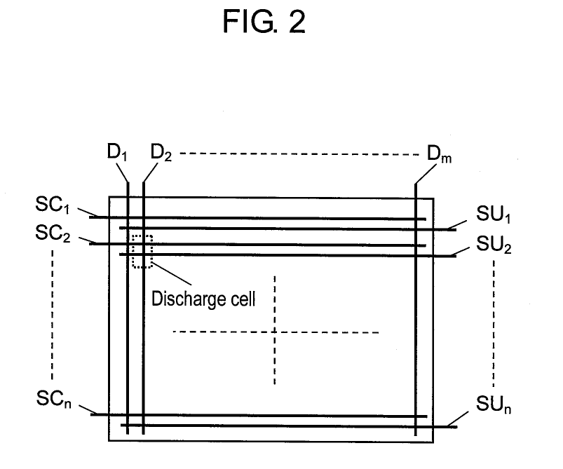

FIG. 2 is a diagram showing the electrode arrangement of panel 10 which is used in the embodiment of the invention. Panel 10 has n scan electrodes SC₁ to SCₙ (scan electrodes 22 of FIG. 1) and n sustain electrodes SU₁ to SUₙ (sustain electrodes 23 of FIG. 1) extending in a row direction (line direction). Panel 10 also has m data electrodes D₁ to Dₘ (data electrodes 32 of FIG. 1) extending in a column direction. Each discharge cell is formed at an intersection of a pair of scan electrode SCᵢ (where i=1 to n) and sustain electrode SUᵢ and one data electrode Dⱼ (where j=1 to m). In the discharge space, m×n discharge cells are formed. A region (image region) where an image is displayed is defined by the m×n discharge cells.

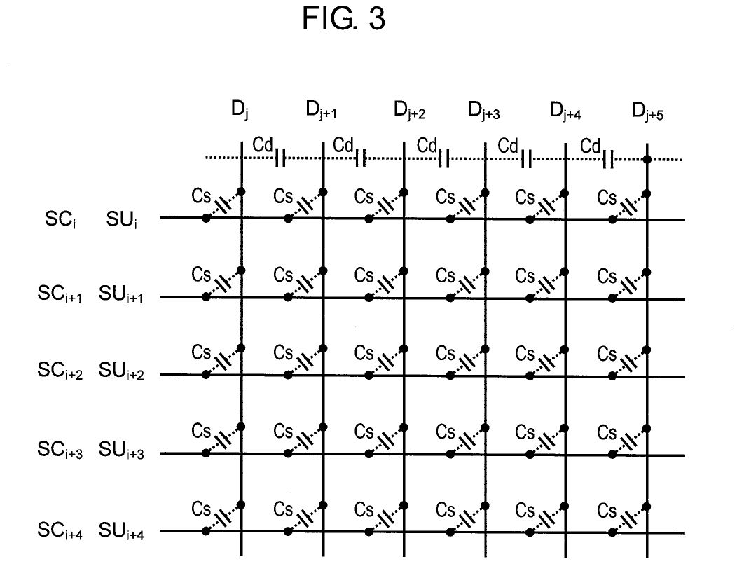

Inter-electrode capacitance exists between the electrodes arranged in such a manner. FIG. 3 is a diagram schematically showing inter-electrode capacitance of panel 10 which is used in the embodiment of the invention. FIG. 3 shows inter-electrode capacitance regarding data electrodes D₁ to Dₘ. Inter-electrode capacitance Cs exists at the intersections of the display electrode pairs and the data electrodes. Inter-electrode capacitance Cd exists between adjacent data electrodes.

FIG. 3 shows inter-electrode capacitance Cs at the intersections of five scan electrodes SCᵢ to SCᵢ₊₄ and sustain electrodes SUᵢ to SUᵢ₊₄, and six data electrodes Dⱼ to Dⱼ₊₅, and inter-electrode capacitance Cd between six data electrodes Dⱼ to Dⱼ₊₅. The display electrode pairs each having scan electrode SCᵢ and sustain electrode SUᵢ is indicated by a single thick horizontal line. That is, in FIG. 3 inter-electrode capacitance between the display electrode pairs and data electrodes Dⱼ is indicated by Cs.

Next, a method of driving panel 10 will be described. In this embodiment, a so-called subfield process is used for displaying gradation. The subfield process divides a field into a plurality of subfields and controls lighting or non-lighting of each discharge cell for each subfield, thereby performing display of gradation. The details regarding the number of subfields and the luminance weights of subfields in this embodiment will be described later.

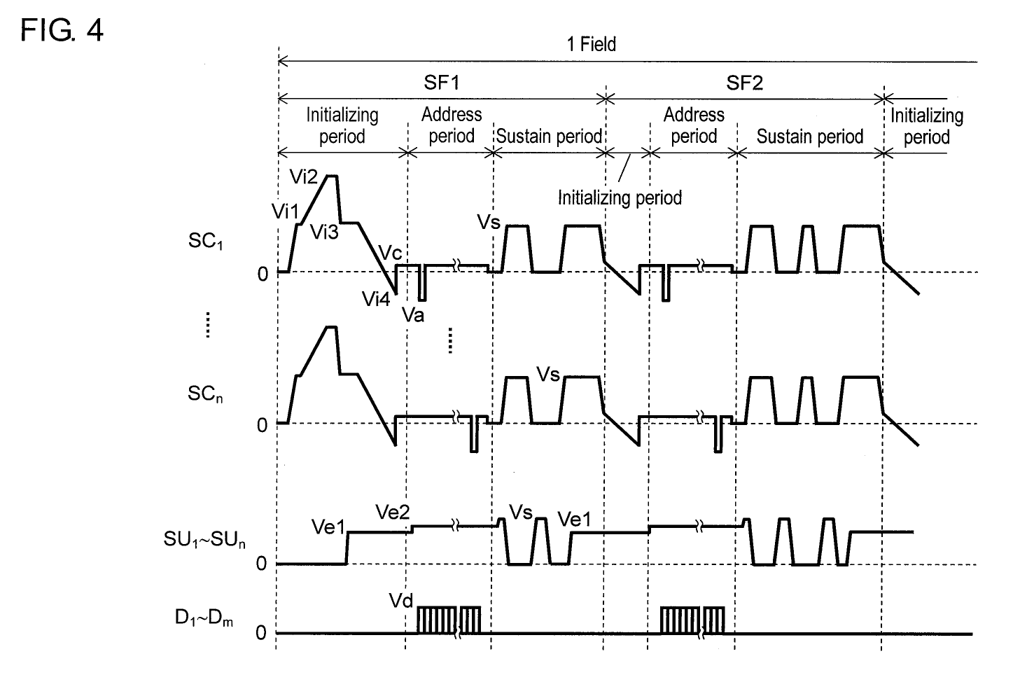

Each subfield has an initializing period, an address period, and a sustain period. FIG. 4 is a diagram showing driving voltage waveforms to be applied to the electrodes of panel 10 of the plasma display device according to the embodiment of the invention. FIG. 4 shows driving voltage waveforms for two subfields SF1 and SF2.

During the initializing period of subfield SF1, 0 (V) is applied to data electrodes D₁ to Dₘ and sustain electrodes SU₁ to SUₙ, and a ramp voltage, which gradually rises from voltage Vi1 toward Vi2, is applied to scan electrodes SC₁ to SCₙ. Thereafter, voltage Ve1 is applied to sustain electrodes SU₁ to SUₙ, and a ramp voltage, which gradually falls from voltage Vi3 toward Vi4, is applied to scan electrodes SC₁ to SCₙ. Then, weak initializing discharge occurs in each discharge cell, and wall charges required for an address operation are formed on the electrodes. With respect to the operation of the initializing period, like the initializing period of subfield SF2 in FIG. 4, a ramp voltage, which gradually falls, may be only applied to scan electrodes SC₁ to SCₙ.

Subsequently, during the address period, voltage Ve2 is applied to sustain electrodes SU₁ to SUₙ, voltage Vc is applied to scan electrodes SC₁ to SCₙ, and 0 (V) is applied to data electrodes D₁ to Dₘ. Next, scan pulse voltage Va is applied to scan electrode SC₁ of a first line, and address pulse voltage Vd is applied to data electrodes Dₖ (where k=1 to m) corresponding to discharge cells to emit light. Then, address discharge occurs in the discharge cells of the first line, to which scan pulse voltage Va and address pulse voltage Vd are applied simultaneously, and an address operation to accumulate wall charges on scan electrode SC1 and sustain electrode SU1 is performed.

The same address operation is performed for the discharge cells of the second line to the n-th line. In this way, address discharge selectively occurs for the discharge cells to emit light, and wall charges are formed.

As shown in FIG. 3, each data electrode Dⱼ is capacitively loaded. Accordingly, during the address period, the capacitance needs to be charged/discharged each time the voltage applied to each data electrode is switched from the ground potential 0 (V) to address pulse voltage Vd or from address pulse voltage Vd to the ground potential 0 (V). If the number of times of charging/discharging is large, power consumption of a data electrode driving circuit described below increases.

During the subsequent sustain period, 0 (V) is applied to sustain electrode SU₁ to SUₙ, and sustain pulse voltage Vs is applied to scan electrodes SC₁ to SCₙ. Then, sustain discharge occurs in the discharge cells where address discharge occurred, and causes the discharge cells to emit light.

Next, voltage 0 (V) is applied to scan electrodes SC₁ to SCₙ, and sustain pulse voltage Vs is applied to sustain electrodes SU₁ to SUₙ. Then, sustain discharge occurs again in the discharge cells where sustain discharge occurred, and causes the discharge cells to emit light. Thereafter, sustain pulses are alternately applied to scan electrodes SC₁ to SCₙ and sustain electrodes SU₁ to SUₙ on the basis of a luminance weight, such that the discharge cells emit light. Thereafter, sustain pulse voltage Vs is applied to scan electrodes SC₁ to SCₙ and voltage Ve1 is applied to sustain electrodes SU₁ to SUₙ so as to perform a so-called wall charge erasure, and the sustain period ends.

Subsequently, in subfield SF2, the same operation as that in the above-described subfield is repeatedly performed so as to cause the discharge cells to emit light. Thus, an image is displayed.

Next, the subfield structure will be described. In this embodiment, it is assumed that one field is divided into 12 subfields (SF1, SF2, . . . , and SF12), and the subfields have luminance weights (1, 2, 4, 8, 12, 20, 24, 28, 32, 36, 40, and 48), respectively.

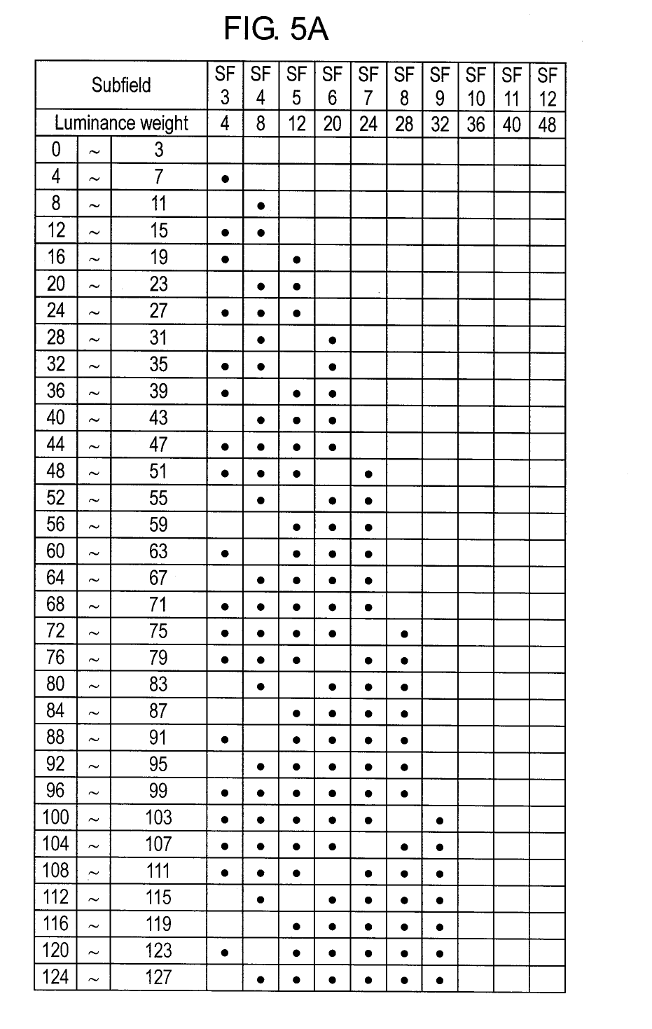

FIGS. 5A and 5B are diagrams showing a gradation to be displayed and a combination of subfields, in which discharge cells are caused to emit light in order to express the gradation (hereinafter, simply referred to as “coding”), in the plasma display device according to the embodiment of the invention. A subfield indicated by “” is a subfield in which discharge cells are caused to emit light. For better viewing of the drawings, subfields SF1 and SF2 having luminance weights to be represented by lower two bits are omitted. FIG. 5A shows a range of gradation values “0” to “127”, and FIG. 5B shows a range of gradation values “128” to “255”.

In order to express the gradation values from “0” to “255”, for example, eight subfields having luminance weights of power of “2” may be used. As well known in the art, however, if such a subfield structure is used, an extremely strong dynamic false contour is generated. Therefore, in this embodiment, the number of the subfields is increased to 12, and a dynamic false contour is suppressed by using coding which ensures little change in the pattern of subfields where discharge cells are caused to emit light.

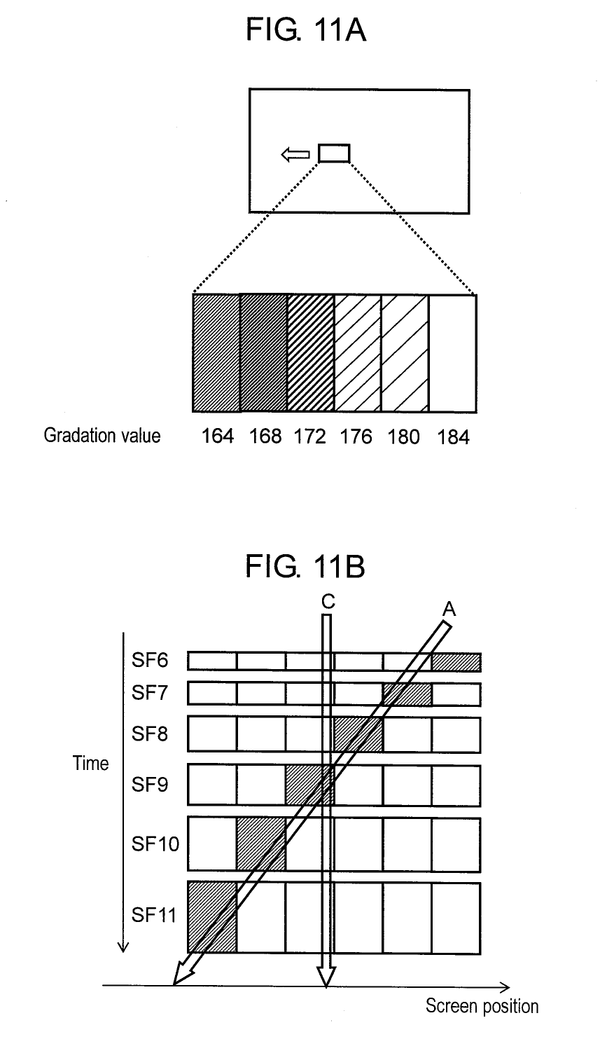

Arrow A in FIG. 5B will be described later together with the description of FIG. 11B.

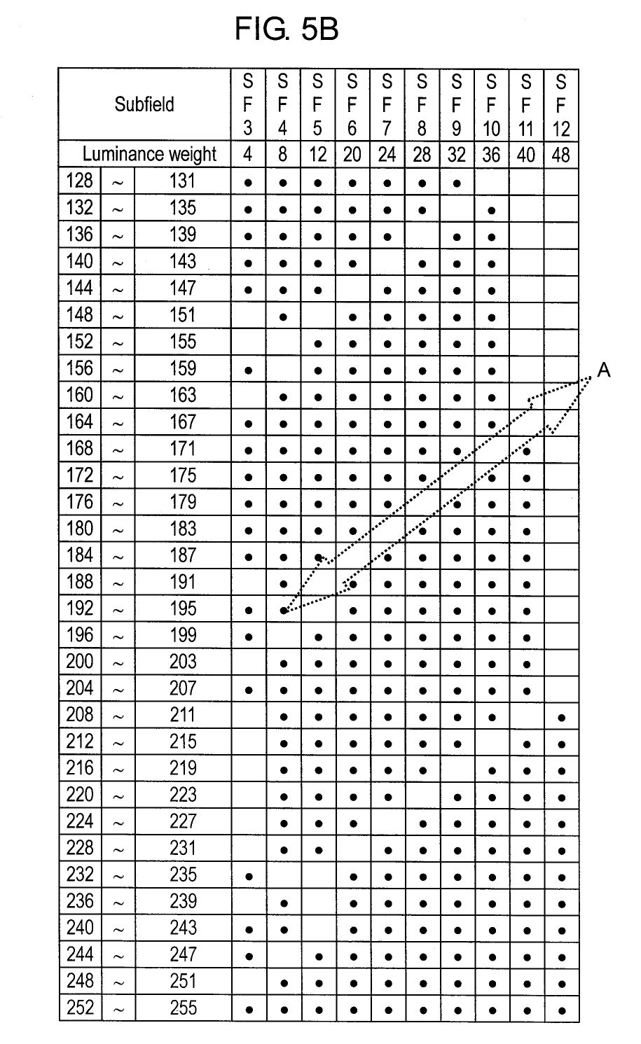

FIG. 6 is a circuit block diagram of plasma display device 100 according to the embodiment of the invention. Plasma display device 100 includes panel 10, image signal processing circuit 41, data electrode driving circuit 42, scan electrode driving circuit 43, sustain electrode driving circuit 44, timing generation circuit 45, and a power supply circuit (not shown) for supplying necessary power to the respective circuit blocks.

Image signal processing circuit 41 performs a dynamic false contour prevention processing on an image signal, and outputs image data corresponding to “1” and “0” of each bit of a digital signal which indicates lighting or non-lighting of each subfield.

Data electrode driving circuit 42 includes m switch circuits SW1 to SWm for applying address pulse voltage Vd or 0 (V) to m data electrodes D₁ to Dₘ, respectively. Data electrode driving circuit 42 converts image data output from image signal processing circuit 41 into address pulse voltage Vd corresponding to respective data electrodes D₁ to Dₘ, and applies address pulse voltage Vd to respective data electrodes D₁ to Dₘ.

Timing generation circuit 45 generates various timing signals for controlling the operations of the circuits on the basis of a horizontal synchronization signal and a vertical synchronization signal, and supplies the timing signals to the circuits. Scan electrode driving circuit 43 drives scan electrodes SC₁ to SCₙ on the basis of the timing signals. Sustain electrode driving circuit 44 drives sustain electrodes SU₁ to SUₙ on the basis of the timing signals.

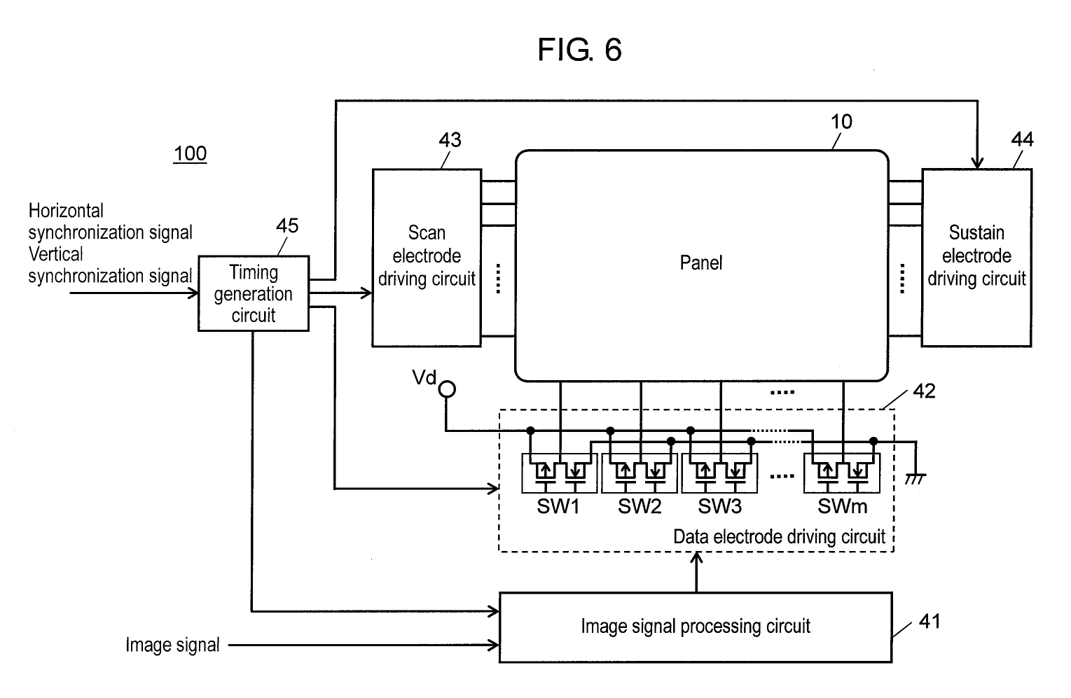

FIG. 7 is a circuit block diagram showing the details of image signal processing circuit 41 of plasma display device 100 according to the embodiment of the invention. Image signal processing circuit 41 includes first false contour suppression circuit 51 for performing a first signal processing, second false contour suppression circuit 52 for performing a second signal processing, selection signal generation circuit 55, image signal selection circuit 56, and image data conversion circuit 58. First false contour suppression circuit 51 performs an image signal processing for suppressing a dynamic false contour to the extent that it is unrecognizable while increasing power consumption of data electrode driving circuit 42 to some extent. This image signal processing is called the first signal processing. Second false contour suppression circuit 52 performs an image signal processing for suppressing a dynamic false contour without increasing power consumption of data electrode driving circuit 42. This image signal processing is called the second signal processing. That is, the second signal processing outputs an image signal which requires lower power consumption of data electrode driving circuit 42 than the first signal processing. Image signal selection circuit 56 selectively outputs one of an image signal output from first false contour suppression circuit 51 and an image signal output from second false contour suppression circuit 52. Selection signal generation circuit 55 generates a selection signal for deciding an image signal selected by image signal selection circuit 56. Image data conversion circuit 58 converts the image signal output from image signal selection circuit 56 into image data representing lighting/non-lighting of each subfield.

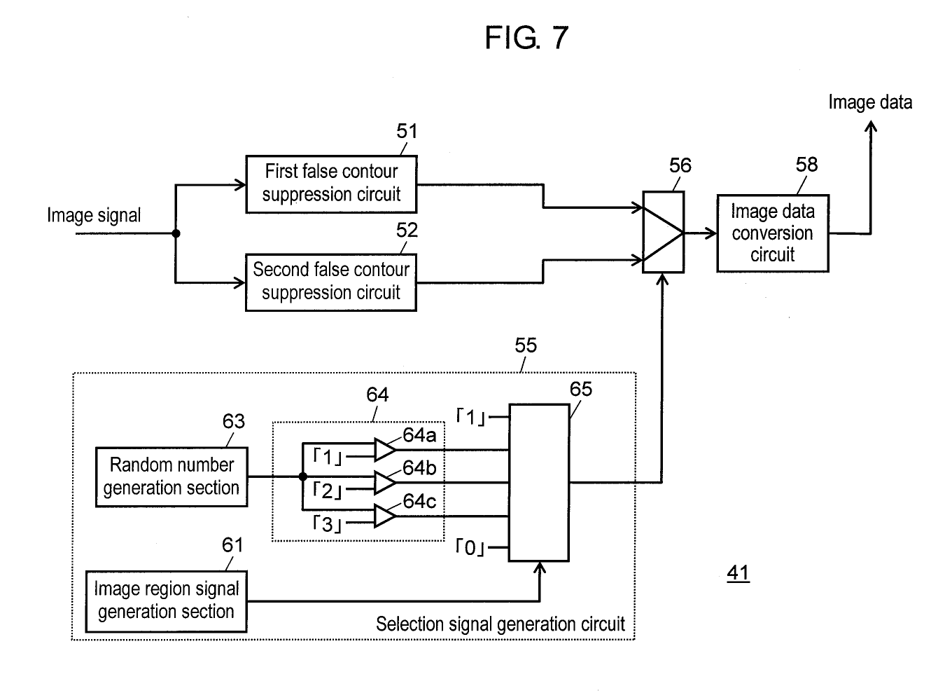

Selection signal generation circuit 55 has image region signal generation section 61, random number generation section 63, binarization section 64, and binarization selection section 65. Image region signal generation section 61 divides the image region into frame-shaped concentric regions, and outputs signals representing the respective regions. FIG. 8 is a diagram illustrating the operation of image region signal generation section 61 of plasma display device 100 according to the embodiment of the invention. In this embodiment, as shown in FIG. 8, the image region is divided into five regions of central region 81, first transition region 82, second transition region 83, third transition region 84, and peripheral region 85. Image region signal generation section 61 outputs, on the basis of the timing signals output from timing generation circuit 45, an image region signal representing which of the 5 regions an image display region corresponding to an image signal is. In this embodiment, the ratio of central region 81 to the entire image display region is, for example, 79% in the vertical direction and 87% in the horizontal direction. Each of first transition region 82, second transition region 83, and third transition region 84 has the upper and lower widths of, for example, 2.6%, and the right and left widths of, for example, 1.5%. Peripheral region 85 has the upper and lower widths of, for example, 2.6%, and the right and left widths of, for example, 1.8%. If it is assumed that the number of pixels of the image region is 768 in the vertical direction and 1366 in the horizontal direction, central region 81 has 608 pixels in the vertical direction and 1194 pixels in the horizontal direction. The upper, lower, right, and left widths of first transition region 82, second transition region 83, and third transition region 84 correspond to 20 pixels. The upper and lower widths of peripheral region 85 correspond to 20 pixels, and the right and left widths of peripheral region 85 correspond to 25 pixels.

In this embodiment, random number generation section 63 generates a random number equal to or more than “0” and less than “4” for each pixel clock generated by timing generation circuit 45.

In this embodiment, binarization section 64 has three comparators 64a, 64b, and 64c. Comparator 64a compares the random number generated by random number generation section 63 with “1”, and when the random number is less than “1”, it outputs “0”, and when the random number is equal to or more than “1”, it outputs “1”. Comparator 64b compares the random number generated by random number generation section 63 with “2”, and when the random number is less than “2”, it outputs “0”, and when the random number is equal to or more than “2”, it outputs “1”. Comparator 64c compares the random number generated by random number generation section 63 with “3”, and when the random number is less than “3”, it outputs “0”, and when the random number is equal to or more than “3”, it outputs “1”.

Binarization selection section 65 selects one of the outputs of the three comparators 64a, 64b, and 64c, “0”, and “1” on the basis of the image region signal output from image region signal generation section 61. Specifically, binarization selection section 65 selects “1” when the image region signal represents central region 81, and selects the output of comparator 64a when the image region signal represents first transition region 82. Binarization selection section 65 selects the output of comparator 64b when the image region signal represents second transition region 83, and selects the output of comparator 64c when the image region signal represents third transition region 84. Binarization selection section 65 selects “0” when the image region signal represents peripheral region 85. Therefore, the selection signal output from binarization selection section 65 is constantly “1” when the image region signal represents central region 81, and is “1” with a probability of ¾ when the image region signal represents first transition region 82. The selection signal output from binarization selection section 65 is “1” with a probability of ½ when the image region signal represents second transition region 83, is “1” with a probability of ¼ when the image region signal represents third transition region 84, and is constantly “0” when the image region signal represents peripheral region 85.

Image signal selection circuit 56 selects an image signal output from first false contour suppression circuit 51 when the selection signal output from binarization selection section 65 is “1”, and selects an image signal output from second false contour suppression circuit 52 when the selection signal is “0”. Therefore, the first signal processing is performed on an image signal to be displayed in central region 81 of the image region of panel 10. With respect to an image signal to be displayed in first transition region 82, the first signal processing is performed with a probability of ¾, and the second signal processing is performed with a probability of ¼. With respect to an image signal to be displayed in second transition region 83, the first signal processing is performed with a probability of ½, and the second signal processing is performed with a probability of ½. With respect to an image signal to be displayed in third transition region 84, the first signal processing is performed with a probability of ¼, and the second signal processing is performed with a probability of ¾. With respect to an image signal to be displayed in peripheral region 85, the second signal processing is performed.

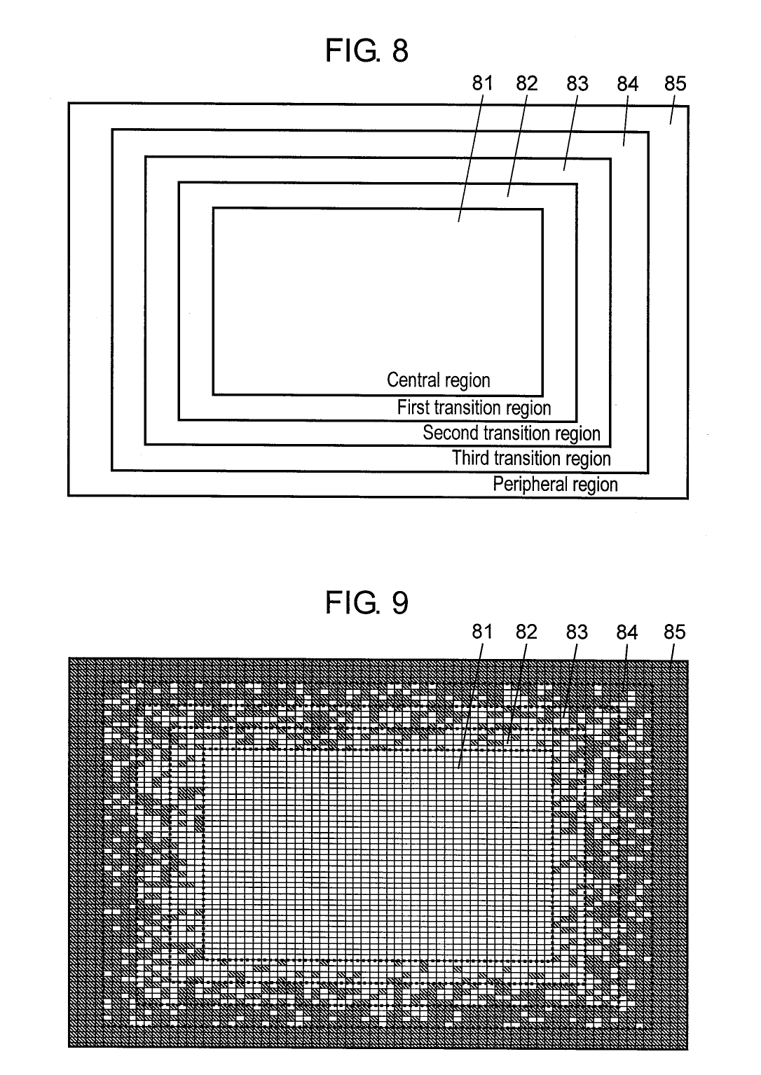

FIG. 9 is a schematic view illustrating the operation of image signal selection circuit 56 of plasma display device 100 according to the embodiment of the invention. With respect to pixels represented in white, the image signal which was subjected to the first signal processing and output from first false contour suppression circuit 51 is selected. With respect to pixels represented in hatched, the image signal which was subjected to the second signal processing and output from second false contour suppression circuit 52 is selected. By selecting the image signal in such a manner, in central region 81 where a dynamic false contour is easily noticeable, an image signal processing for suppressing a dynamic false contour to the extent that it is unrecognizable is performed. In peripheral region 85 where a dynamic false contour is difficult to be noticeable, an image signal processing for suppressing a dynamic false contour without increasing power consumption of data electrode driving circuit 42 is performed. In this way, in a region where a dynamic false contour is easily noticeable, a dynamic false contour is suppressed to the extent that it is unrecognizable. Meanwhile, in a region where a dynamic false contour is difficult to be noticeable, power consumption is preferentially suppressed. Therefore, a dynamic false contour can be effectively suppressed while an increase in power consumption can be suppressed. In addition, if a transition region is provided between central region 81 and peripheral region 85, and a selection ratio of an image signal in the transition region gradually changes, display images of central region 81 and peripheral region 85 can be smoothly connected to each other.

For first false contour suppression circuit 51 and second false contour suppression circuit 52, various circuits may be used. In this embodiment, since a dynamic false contour is somehow suppressed by using coding, which ensures little change in the pattern of subfields where discharge cells are caused to emit light, it is assumed that, for second false contour suppression circuit 52, a circuit which outputs an input image signal unchanged is used. In addition, it is assumed that, for first false contour suppression circuit 51, for example, a circuit which selects one of a plurality of corrected gradations set for the gradations of an image signal and substitutes the selected corrected gradation for an original gradation is used.

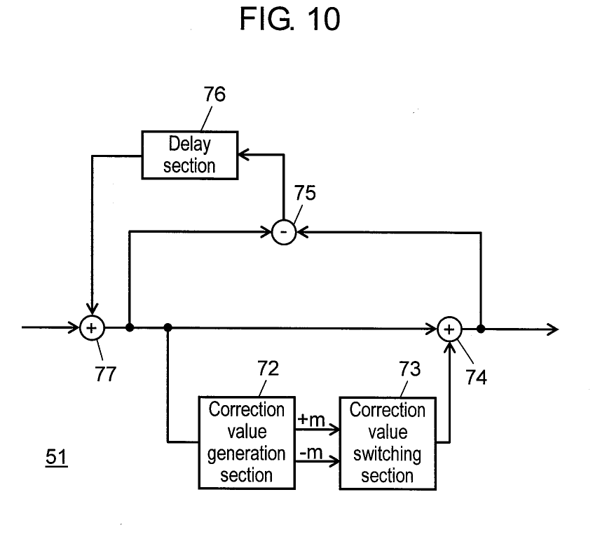

FIG. 10 is a circuit block diagram of first false contour suppression circuit 51 of plasma display device 100 according to the embodiment of the invention. First false contour suppression circuit 51 includes correction value generation section 72, correction value switching section 73, addition section 74, subtraction section 75, delay section 76, and addition section 77. First false contour suppression circuit 51 corrects a predetermined gradation of an image signal to a plurality of other gradations, and disperses an intermediate non-lighting subfield, which causes a dynamic false contour, thereby suppressing a dynamic false contour.

Correction value generation section 72 generates two correction values “−m” and “+m” for each gradation of the image signal. Correction value switching section 73 switches the two correction values in a pixel unit, alternately in a line unit, or randomly. Addition section 74 adds the output of correction value switching section 73 and the image signal to convert a predetermined signal of the image signal into a corrected gradation, and outputs the corrected gradation as a corrected image signal. Since the correction values have the values “−m” and “+m”, the average value of corrected gradations obtained by adding the correction values is equal to the gradation before correction. In addition, since correction value switching section 73 switches the correction values in a pixel unit, alternately in a line unit, or randomly, the average value of the corrected image signal is not changed by correction.

Subtraction section 75 calculates a difference between the image signal before correction and the corrected image signal to generate a difference signal. The difference signal is delayed by predetermined delay section 76, and is added to an input signal by using addition section 77. If such a feedback circuit structure is used as a gradation correction section, the average gradation value including peripheral pixels can approximate to the gradation value before correction, an error in the gradation associated with gradation correction can be corrected in a pseudo manner.

Next, the operation of first false contour suppression circuit 51 will be described. In this embodiment, a gradation based on coding shown in FIG. 5 is displayed. However, if the combination is used unchanged for a gradient gradation region where there is a movement, a strong dynamic false contour may occur.

FIGS. 11A and 11B are diagrams illustrating why a dynamic false contour occurs in a gradient gradation region where there is a movement. As shown in FIG. 11A, for example, assume an image in which a gradient gradation region, which is darker on the left side and becomes brighter on the right side in a range of gradation values “164” to “184”, moves to the left direction. FIG. 11B is a diagram showing a case in which the gradient gradation region is developed to subfields. In FIG. 11B, the horizontal axis denotes a screen position in the horizontal direction, and the vertical axis denotes a time elapsed. For better viewing of the drawing, only six subfields (SF6, SF7, . . . , and SF11) are shown. In FIG. 11B, hatched regions represent non-lighting subfields. If the gradient gradation region remains stationary, as indicated by arrow C, the line of sight of a human being remains stationary on the screen, and thus the original gradation can be recognized. Meanwhile, if the gradient gradation region moves to the left direction, the line of sight also moves to the left direction, and as a result, in the region indicated by arrow A, the line of sight follows a maximum intermediate non-lighting subfield (a subfield having a maximum luminance weight among intermediate non-lighting subfields). For this reason, the human being recognizes an extremely dark line in the gradient gradation region. Arrow A of FIG. 5B represents the same movement of the line of sight as arrow A of FIG. 11B.

As described above, it is known that when the line of sight moves at a speed following the intermediate non-lighting subfield in the gradient gradation region, a strong dynamic false contour occurs. In the above example, if the line of sight moves at such a speed that subfields SF6 to SF11 pass while the gradation value increases from “164” to “184”, the human being continuously recognizes the maximum intermediate non-lighting subfield, and a dark line appears as a dynamic false contour.

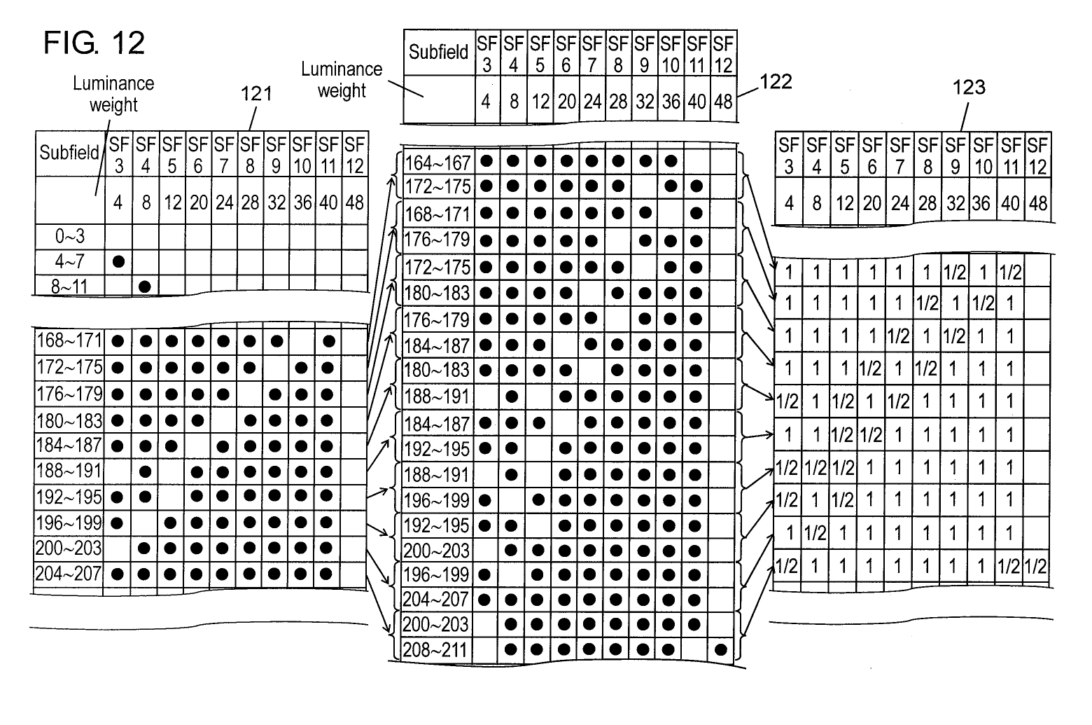

FIG. 12 is a diagram showing a correction pattern of first false contour suppression circuit 51 of plasma display device 100 according to the embodiment of the invention. Table 121 shows the relation between a gradation value before correction and a lighting subfield, and Table 122 shows the relation between a gradation value after correction and a lighting subfield. For simple explanation, table 121 shows the gradations ranging from “168” to “207”. First false contour suppression circuit 51 corrects the gradation to light the maximum intermediate non-lighting subfield before correction, and sets previous and subsequent subfields as non-lighting subfields with a probability of ½. That is, first false contour suppression circuit 51 selects a gradation, which lights the maximum intermediate non-lighting subfield before correction, as a corrected gradation, to thereby disperse the maximum intermediate non-lighting subfield, which causes the dynamic false contour, to the previous and subsequent subfields. With respect to a signal of gradation “168”, first false contour suppression circuit 51 adds correction values −m=−4 and +m=4 so as to convert the gradation “168” into corrected gradations of a gradation “164” and a gradation “172”, and outputs the corrected gradations alternately in a pixel unit and in a line unit. In this case, the original gradation “168” is corrected to one of the corrected gradations “164” and “172”, but since the correction probability during each conversion is ½, the original gradation “168” as the average is maintained.

Table 123 shows an average lighting probability of subfields for gradations of an image display device according to the embodiment of the invention. The numerical value of each column is a lighting probability after correction. Here, “1” and “½” represent lighting probabilities 1 and ½, respectively, and a blank represents a lighting probability 0. For example, with respect to the signal of gradation “168”, the maximum intermediate non-lighting subfield before correction is subfield SF10, and the lighting probability of subfield SF10 is 0. Meanwhile, the intermediate non-lighting subfield after correction is dispersed to subfields SF9 and SF11, and the lighting probabilities of subfields SF9 and SF11 become ½. For this reason, the dynamic false contour in the corrected region is dispersed, and as a result, image display quality is improved.

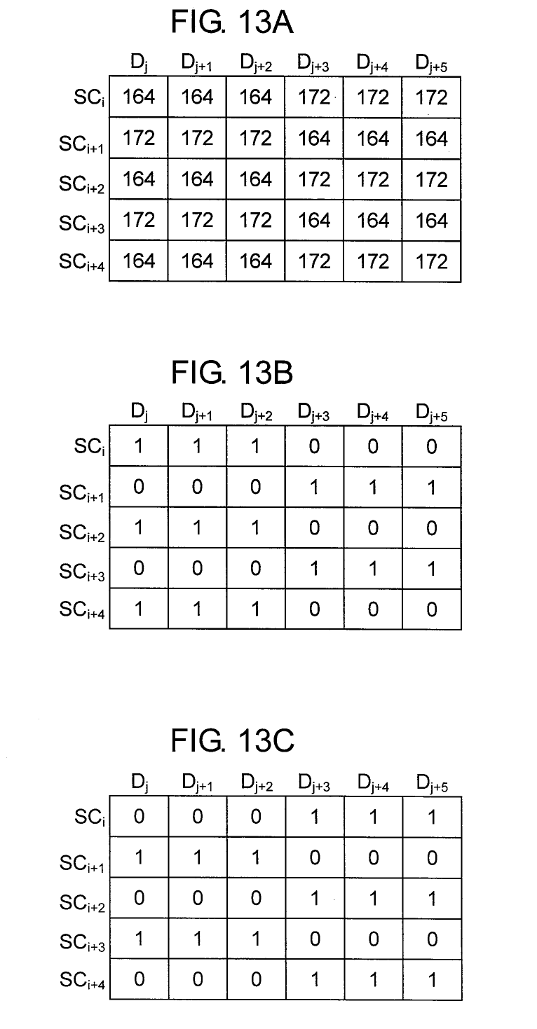

However, if such correction is performed, the number of subfields in which a light-emitting pixel and a non-light-emitting pixel are close to each other increases, and accordingly power for driving the data electrodes also increases. For example, with respect to the signal of gradation “168”, it is assumed that the gradation “168” is converted into two corrected gradations of a gradation “164” and a gradation “172”, and the corrected gradations are switched alternately in pixel unit and in a line unit to output a pattern in which the corrected gradations are arranged checkerwise. FIGS. 13A to 13C are diagrams showing a pattern in which a gradation “164” and a gradation “172” are arranged checkerwise. FIGS. 13A to 13C show pixels corresponding to discharge cells of 2 pixels×5 lines, that is, 6×5=30. FIG. 13A shows gradations of discharge cells defined by scan electrodes SCᵢ to SCᵢ₊₄ and data electrodes Dⱼ to Dⱼ₊₅. FIG. 13B shows presence/absence of an address operation of discharge cells defined by scan electrodes SCᵢ to SCᵢ₊₄ and data electrodes Dⱼ to Dⱼ₊₅ in subfield SF9. FIG. 13C shows presence/absence of an address operation of discharge cells defined by scan electrodes SCᵢ to SCᵢ₊₄ and data electrodes Dⱼ to Dⱼ₊₅ in subfield SF11. In FIGS. 13B and 13C, “1” represents a discharge cell where there is an address operation, and “0” represents a discharge cell where there is no address operation. In this way, an address operation is performed with a checked pattern in subfields SF9 and SF11.

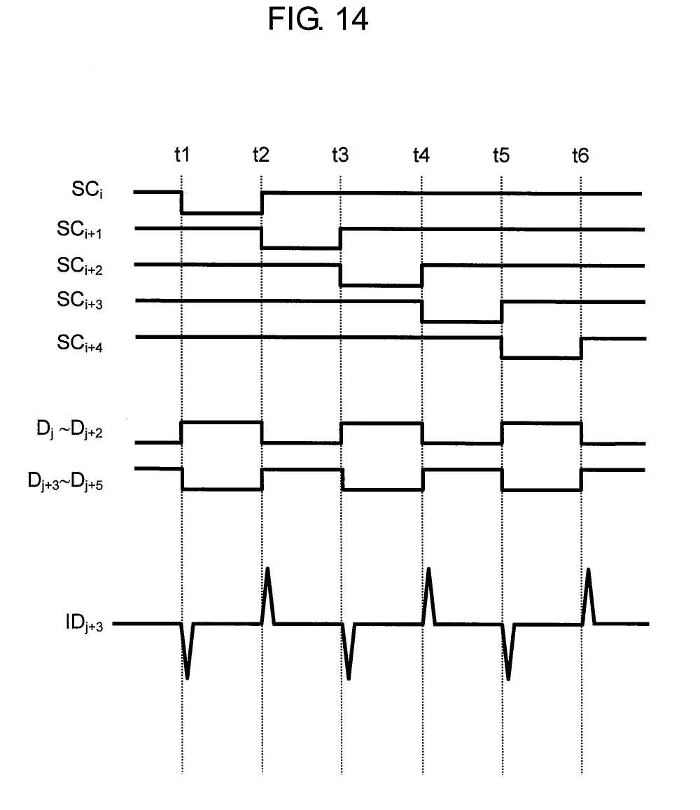

FIG. 14 is a diagram for estimation of power consumption of data electrode driving circuit 42 when a checked pattern shown in FIG. 13 is displayed. FIG. 14 shows scan pulses that are applied to scan electrodes SCᵢ to SCᵢ₊₄ during the address period of subfield SF9, address pulses that are applied to data electrodes Dⱼ to Dⱼ₊₅, and current waveform IDⱼ₊₃ flowing in data electrode Dⱼ₊₃. During a period from time t1 to time t2, a scan pulse is applied to scan electrode SCᵢ, and address pulses are applied to data electrodes Dⱼ to Dⱼ₊₂, to thereby cause address discharge. In this case, no address pulse is applied to data electrodes Dⱼ₊₃ to Dⱼ₊₅, and accordingly address discharge is not generated. During a period from time t2 to time t3, a scan pulse is applied to scan electrode SCᵢ₊₁, and address pulses are applied to data electrodes Dⱼ₊₃ to Dⱼ₊₅, to thereby cause address discharge. No address pulse is applied to data electrodes Dⱼ to Dⱼ₊₂, and accordingly address discharge is not generated. Similarly, the address pulses shown in FIG. 14 are applied, and thus the discharge cells indicated by “1” in FIG. 13B emit light in subfield SF9.

In this case, with focusing on the current IDⱼ₊₃ flowing in the data electrode Dⱼ₊₃, current flows to charge/discharge inter-electrode capacitance Cs between scan electrodes SC₁ to SCₙ and sustain electrodes SU₁ to SUₙ, and data electrodes Dⱼ₊₃. In addition, a current flows to charge/discharge inter-electrode capacitance Cd against the address pulse to be applied in opposite phase to data electrode Dⱼ₊₂ adjacent to data electrode Dⱼ₊₃. For this reason, during the address period of subfield SF9, power consumption of data electrode driving circuit 42 increases. The same is applied to the address period of subfield SF11.

As described above, according to first false contour suppression circuit 51, a dynamic false contour can be effectively suppressed, but the number of subfields where a checked pattern is displayed increases. For this reason, power consumption of data electrode driving circuit 42 becomes high.

In this embodiment, the image signal processing with high power consumption of data electrode driving circuit 42 is performed only in central region 81 where a dynamic false contour is easily noticeable. Meanwhile, in this embodiment, in peripheral region 85 where a dynamic false contour is difficult to be noticeable, power consumption is preferentially suppressed. In this way, a dynamic false contour can be effectively suppressed while power consumption can be suppressed. If a transition region is provided between central region 81 and peripheral region 85, and a selection ratio of an image signal in the transition region gradually changes, display images of central region 81 and peripheral region 85 can be smoothly connected to each other.

In this embodiment, as first false contour suppression circuit 51, a circuit that disperses an intermediate non-lighting subfield to suppress a dynamic false contour is used, and as second false contour suppression circuit 52, a circuit that outputs an input image signal unchanged is used. However, the invention is not limited thereto, and various circuits may be used. For example, as first false contour suppression circuit 51 and second false contour suppression circuit 52, circuits that disperse an intermediate non-lighting subfield to suppress a dynamic false contour may be used. In this case, first false contour suppression circuit 51 may disperse the maximum intermediate non-lighting subfield in a wider range than second false contour suppression circuit 52, and the subfields may have a high lighting probability. As first false contour suppression circuit 51, a circuit that performs dithering to make the number of gradations to be displayed larger than the number of gradations in second false contour suppression circuit 52 may be used. With respect to other circuits, a circuit that performs an image signal processing to output an image signal with good image display quality while increasing power consumption of data electrode driving circuit 42 to some extent, and a circuit that performs an image signal processing to output an image signal with power consumption of data electrode driving circuit 42 preferentially suppressed may be applied to the invention as first false contour suppression circuit 51 and as second false contour suppression circuit 52, respectively.

The number of subfields, the luminance weight, and other specific numerical values used in this embodiment are just for illustrative purposes, and preferably, optimum values are appropriately set depending on the characteristics of the panel or the specification of the plasma display device.

As will be apparent from the above description, according to the invention, it is possible to provide a plasma display device that can effectively suppress a dynamic false contour while suppressing an increase in power consumption.

### INDUSTRIAL APPLICABILITY

The invention is useful for a plasma display device which can effectively suppress a dynamic false contour while suppressing an increase in power consumption, and in particular, a large-screen plasma display device.

1. A plasma display device comprising:
a plasma display panel having a plurality of discharge cells each having a data electrode;
a data electrode driving circuit for driving the data electrodes; and
an image signal processing circuit for performing a signal processing on an image signal and supplying the processed image signal to the data electrode driving circuit,
wherein the image signal processing circuit performs a first signal processing on an image signal to be displayed in a central region of an image region of the plasma display panel, and performs a second signal processing on an image signal to be displayed in a peripheral region of the image region, and
the second signal processing outputs the image signal which needs lower power consumption of the data electrode driving circuit than the first signal processing.

2. A plasma display device of claim 1,
wherein the image signal processing circuit is provided in a transition region between the central region and the peripheral region, and
one of the first signal processing and the second signal processing is performed on an image signal to be displayed in the transition region with a predetermined probability.

3. The plasma display device of claim 1,
wherein the first signal processing selects one of a plurality of corrected gradations set for the gradations of the image signal and substitutes the selected corrected gradation for an original gradation.
